(19) United States
(12) Patent Application Publication
(10) Pub. No.: US 2021/0277832 A1
(43) Pub. Date: Sep. 9, 2021

(54) ROTATIONAL SUPPORT FOR AN INTERDIGITATED ROTOR ASSEMBLY

(71) Applicant: GE Avio S.r.l., Rivalta di Torino (IT)

(72) Inventors: Roberto Maddaleno, Lanzo Torinese (IT); Matteo Renato Usseglio, Turin (IT); Darek Tomasz Zatorski, Fort Wright, OH (US)

(21) Appl. No.: 17/178,371

(22) Filed: Feb. 18, 2021

(30) Foreign Application Priority Data
Mar. 6, 2020 (IT) 102020000004828

(51) Int. Cl. F02C 7/36; F01D 25/16

(52) U.S. Cl. CPC F02C 7/36; F01D 25/162; F05D 2260/40; F05D 2240/60; F05D 2240/50; F05D 2220/323

(57) ABSTRACT

Turbomachines and turbine sections of a turbomachine are provided. For example, a turbomachine comprises a turbine section having a turbine comprising a first plurality and a second plurality of turbine rotor blades, which are alternatingly spaced along an axial direction. At least one turbine blade of the first plurality of turbine blades is attached to a first support member assembly and at least one turbine blade of the second plurality of turbine blades is attached to a second support member assembly. The turbomachine further comprises a spool that connects the turbine with one or more components outside the turbine section, a first rotational support, and a gearbox. Both the first support member assembly and the second support member assembly are attached to the first rotational support and coupled to the gearbox such that the first and second pluralities of turbine rotor blades are rotatable with one another through the gearbox.

### PRIORITY INFORMATION

The present application claims priority to Italian Patent Application Number 102020000004828 filed on Mar. 6, 2020.

### FIELD

The present subject matter relates generally to a turbomachine and, more particularly, to a rotational support for an interdigitated rotor assembly of a turbine of a turbomachine.

### BACKGROUND

Typical aircraft propulsion systems include one or more gas turbine engines. For certain propulsion systems, the gas turbine engines generally include a fan and a core arranged in flow communication with one another. Additionally, the core of the gas turbine engine general includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

General gas turbine engine design criteria often include conflicting criteria that must be balanced or compromised, including increasing fuel efficiency, operational efficiency, and/or power output while maintaining or reducing weight, part count, and/or packaging (i.e., axial and/or radial dimensions of the engine). Accordingly, at least certain gas turbine engines include interdigitated rotors. For example, a turbine section may include a turbine having a first plurality of low speed turbine rotor blades and a second plurality of high speed turbine rotor blades. The first plurality of low speed turbine rotor blades may be interdigitated with the second plurality of high speed turbine rotor blades. Such a configuration may result in a more efficient turbine.

However, several problems may arise with such a configuration relating to unwanted vibrations, clearance issues between the first and second pluralities of rotor blades, etc. For instance, the first plurality of low speed turbine rotor blades and the second plurality of high speed turbine rotor blades each generate an axial force or load, which typically is supported by a static structure in the region of the turbine section. Further, typical components for transferring the axial loads, such as ball, roller, and/or thrust bearings, may be located such that relatively large gaps are defined between the rows of low speed turbine rotor blades and high speed turbine rotor blades, which can decrease the efficiency of the engine.

Accordingly, a propulsion system for an aircraft having one or more gas turbine engines with one or more components for supporting interdigitated rotors of a turbine section of each engine would be useful. For example, a gas turbine engine having a turbine section with an intershaft support disposed axially near interdigitated rotors of the turbine section would be desirable. Additionally, a propulsion system including a gas turbine engine with a turbine capable of overcoming the various issues with the interdigitated rotors that additionally overcomes the above issues that may arise therewith would be particularly useful.

### BRIEF DESCRIPTION

Aspects and advantages of the invention will be set forth in part in the following description, or may be obvious from the description, or may be learned through practice of the invention.

In one exemplary embodiment of the present subject matter, a turbomachine defining a radial direction and an axial direction is provided. The turbomachine comprises a turbine section comprising a turbine. The turbine comprises a first plurality of turbine rotor blades and a second plurality of turbine rotor blades. The first plurality of turbine rotor blades and second plurality of turbine rotor blades are alternatingly spaced along the axial direction. At least one turbine blade of the first plurality of turbine blades is attached to a first support member assembly and at least one turbine blade of the second plurality of turbine blades is attached to a second support member assembly. The turbomachine further comprises a spool that connects the turbine with one or more components outside the turbine section, a first rotational support, and a gearbox. Both the first support member assembly and the second support member assembly are attached to the first rotational support. Moreover, both the first support member assembly and the second support member are assembly coupled to the gearbox such that the first plurality of turbine rotor blades and second plurality of turbine rotor blades are rotatable with one another through the gearbox.

In another exemplary embodiment of the present subject matter, a turbine section of a turbomachine is provided. The turbine section comprises a turbine. The turbine comprises a first plurality of turbine rotor blades and a second plurality of turbine rotor blades, and the first plurality of turbine rotor blades and second plurality of turbine rotor blades are alternatingly spaced along the axial direction. At least one turbine blade of the first plurality of turbine blades is attached to a first support member assembly and at least one turbine blade of the second plurality of turbine blades is attached to a second support member assembly. The turbine section also comprises a first rotational support, a gearbox, and a turbine center frame having an inner center frame support member extending axially aft from a forward end of the turbine section to the gearbox. Both the first support member assembly and the second support member assembly are attached to the first rotational support, and both the first support member assembly and the second support member assembly are coupled to the gearbox such that the first plurality of turbine rotor blades and second plurality of turbine rotor blades are rotatable with one another through the gearbox. The first support member assembly is connected to a spool, and the inner center frame support member is disposed between the first rotational support and the spool.

In a further exemplary embodiment of the present subject matter, a turbine section of a turbomachine is provided. The turbine section comprises a low pressure turbine that comprises a first plurality of turbine rotor blades and a second plurality of turbine rotor blades. The first plurality of turbine rotor blades and second plurality of turbine rotor blades are alternatingly spaced along the axial direction. At least one turbine blade of the first plurality of turbine blades is attached to a first support member assembly and at least one turbine blade of the second plurality of turbine blades is attached to a second support member assembly. The turbine section further comprises a ball bearing, a gearbox, and a turbine center frame having an inner center frame support member extending axially from a forward end of the turbine section aft to the gearbox. Each of the first support member assembly and the second support member assembly are attached to the ball bearing. Moreover, each of the first support member assembly and the second support member assembly are coupled to the gearbox such that the first plurality of turbine rotor blades and second plurality of turbine rotor blades are rotatable with one another through the gearbox. The first plurality of turbine rotor blades are configured to rotate in a first circumferential direction and the second plurality of turbine rotor blades are configured to rotate in a second circumferential direction. The second circumferential direction is opposite the first circumferential direction. Further, the first support member assembly is connected to a low speed spool, and the low speed spool is drivingly connected to a low pressure compressor disposed forward of the turbine section. The inner center frame support member is disposed between the ball bearing and the low speed spool.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a schematic cross-section view of an exemplary gas turbine engine according to various exemplary embodiments of the present subject matter.

FIGS. 2-5 provide schematic cross-sectional views of a turbine section of a turbomachine, such as the gas turbine engine of FIG. 1, according to various exemplary embodiments of the present subject matter.

FIGS. 6 and 7 provide close-up, schematic cross-sectional views of the turbine section, according to various exemplary embodiments of the present subject matter.

Repeat use of reference characters in the present specification and drawings is intended to represent the same or analogous features or elements of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” “third,” etc. may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching and indirect coupling, fixing, or attaching through one or more intermediate components or features, unless otherwise specified herein.

The singular forms “a,” “an,” and “the” include plural references unless the context clearly dictates otherwise.

The terms “low,” “high,” or their respective comparative degrees (e.g., lower, higher, where applicable) each refer to relative speeds within an engine, unless otherwise specified. For example, a “low turbine” or “low speed turbine” defines a rotational speed generally lower than a “high turbine” or “high speed turbine.” Alternatively, unless otherwise specified, the aforementioned terms may be understood in their superlative degree. For example, a “low turbine” may refer to the lowest maximum rotational speed turbine within a turbine section, and a “high turbine” may refer to the highest maximum rotational speed turbine within the turbine section. As used herein, “high turbine” or “high speed turbine” generally refers to one or more turbine rotors defining a higher maximum rotational speed than the low turbine or low speed turbine. Still further, reference to the “high turbine” may include a plurality thereof, each defining one or more maximum rotational speeds separate or independent from one another and greater than a maximum rotational speed of the low speed turbine.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged; such ranges are identified and include all the sub-ranges contained therein unless context or language indicates otherwise. For example, all ranges disclosed herein are inclusive of the endpoints, and the endpoints are independently combinable with each other.

Generally, the present subject matter provides an intershaft rotational support of a turbine section of a turbomachine. The intershaft rotational support may be attached to a first support member assembly and a second support member assembly and disposed proximate a gearbox to which the first and second support member assemblies also are attached. In exemplary embodiments, the first support member assembly is a low-speed rotor and the second support member assembly is a high-speed rotor, and a plurality of turbine rotor blades are attached to each of the low-speed rotor and the high-speed rotor such that the low-speed turbine rotor blades and high-speed turbine rotor blades are alternatingly spaced along the axial direction to form an interdigitated turbine. The intershaft rotational support, for example, axially and radially connects the high-speed rotor to the low-speed rotor to transfer the axial force generated in the blades of the high-speed rotor to the low-speed rotor. In turn, the axial thrust generated by the high-speed rotor and the low-speed rotor may be partially balanced by other components of the turbomachine, e.g., the axial force of a fan disposed upstream of the turbine section, and the remaining or resulting force may be transferred to a static structure of the engine, e.g., a static frame located away from or outside of the turbine section. As described herein, the intershaft rotational support may reduce the static structure needed to support the axial load of the turbine section in the region of the turbine section; may allow an increase in efficiency of the turbomachine, e.g., by reducing axial gaps between airfoils in the turbine section; and may reduce part count, engine weight, and cost, e.g., by allowing a common sump, a common scavenge, and/or a common thermal barrier for both the intershaft rotational support and the gearbox. Additionally, the embodiments provided herein generally may enable interdigitation, or further extend interdigitation, of a first rotor assembly among one or more second rotor assembly assemblies. Such interdigitation may enable increased gas turbine engine efficiency, improved performance, decreased fuel burn, and improved operability of the engine at higher rotational speeds.

An interdigitated compressor or turbine section may increase fuel efficiency, operational efficiency, and/or power output while reducing weight, part count, and/or packaging (e.g., radial and/or axial dimensions). For example, the interdigitated compressor or turbine section may enable increased bypass ratio and/or overall pressure ratio of the gas turbine engine, thereby increasing fuel efficiency, operational efficiency, and/or power output relative to other engines of similar power output and/or packaging. The interdigitated compressor or turbine section may further reduce stationary and/or rotating airfoil quantities, and thereby engine packaging and/or weight, while maintaining or improving efficiencies, performance, or power output. Still further, the interdigitated turbine section may reduce a product of axial flow area and the square of the rotational speed (the product referred to as “AN²”) while additionally reducing an average work factor per stage of the turbine section.

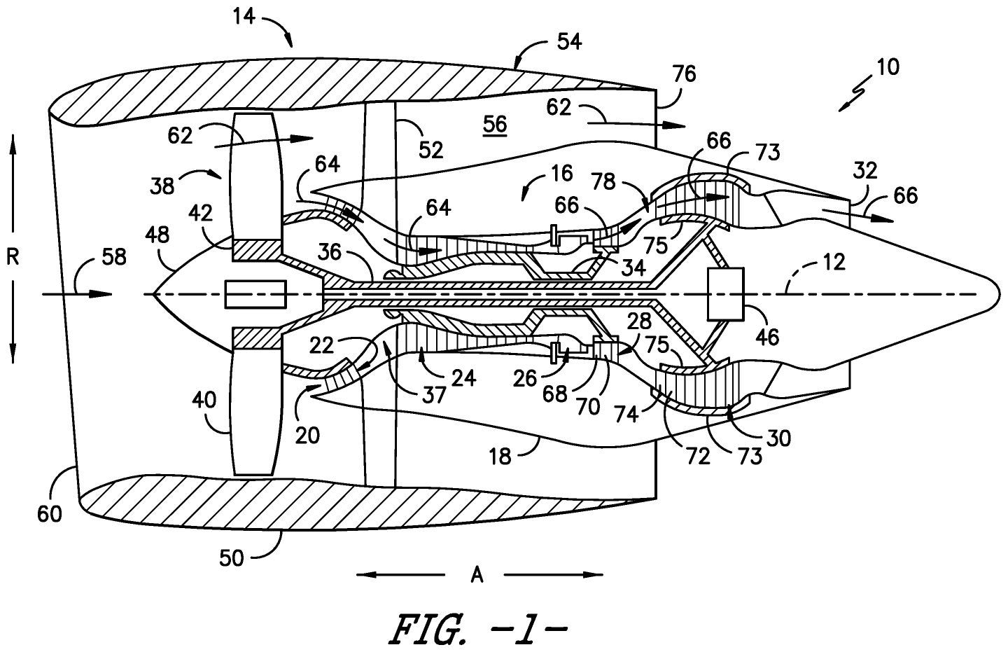

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R, and a circumferential direction (i.e., a direction extending about the axial direction A, not depicted). In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. The compressor section, combustion section 26, and turbine section together define a core air flowpath 37 extending from the annular inlet 20 through the LP compressor 22, HP compressor 24, combustion section 26, HP turbine section 28, LP turbine section 30 and jet nozzle exhaust section 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

For the depicted embodiment, the fan section 14 includes a fan 38 having a plurality of fan blades 40 coupled to a disk 42 in a spaced apart manner. As depicted, the fan blades 40 extend outwardly from disk 42 generally along the radial direction R. In some embodiments, the fan 38 may be a variable pitch fan, and each fan blade 40 may be rotatable relative to the disk 42 about a pitch axis extending radially through the blade by virtue of the fan blades 40 being operatively coupled to a suitable actuation member (not shown) configured to collectively vary the pitch of the fan blades 40 in unison. The fan blades 40 and disk 42, as well as the actuation member in embodiments in which the fan 38 is a variable pitch fan, are together rotatable about the longitudinal axis 12 by LP shaft 36 across a power gearbox 46. The power gearbox 46 includes a plurality of gears for stepping down the rotational speed of the LP shaft 36 to a more efficient rotational fan speed.

Referring still to the exemplary embodiment of FIG. 1, the disk 42 is covered by rotatable front nacelle 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that for the depicted embodiment, the nacelle 50 is supported relative to the core turbine engine 16 by a plurality of circumferentially-spaced outlet guide vanes 52. Moreover, a downstream section 54 of the nacelle 50 extends over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of a first plurality of LP turbine rotor blades 72 that are coupled to an outer drum 73, and a second plurality of turbine rotor blades 74 that are coupled to an inner drum 75. The first plurality of turbine rotor blades 72 and second plurality of turbine rotor blades 74 are alternatingly spaced, or interdigitated, and rotatable with one another through a gearbox (not shown) to together drive the LP shaft or spool 36, thus causing the LP shaft or spool 36 to rotate. Such thereby supports operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It should be appreciated, however, that the exemplary turbofan engine 10 depicted in FIG. 1 is by way of example only, and that in other exemplary embodiments, the turbofan engine 10 may have any other suitable configuration. For example, in other exemplary embodiments, the turbine fan engine 10 may instead be configured as any other suitable turbomachine including, e.g., any other suitable number of shafts or spools, and excluding, e.g., the fan 38, etc. Accordingly, it will be appreciated that in other exemplary embodiments, the turbofan engine 10 may instead be configured as, e.g., a turbojet engine, a turboshaft engine, a turboprop engine, etc.

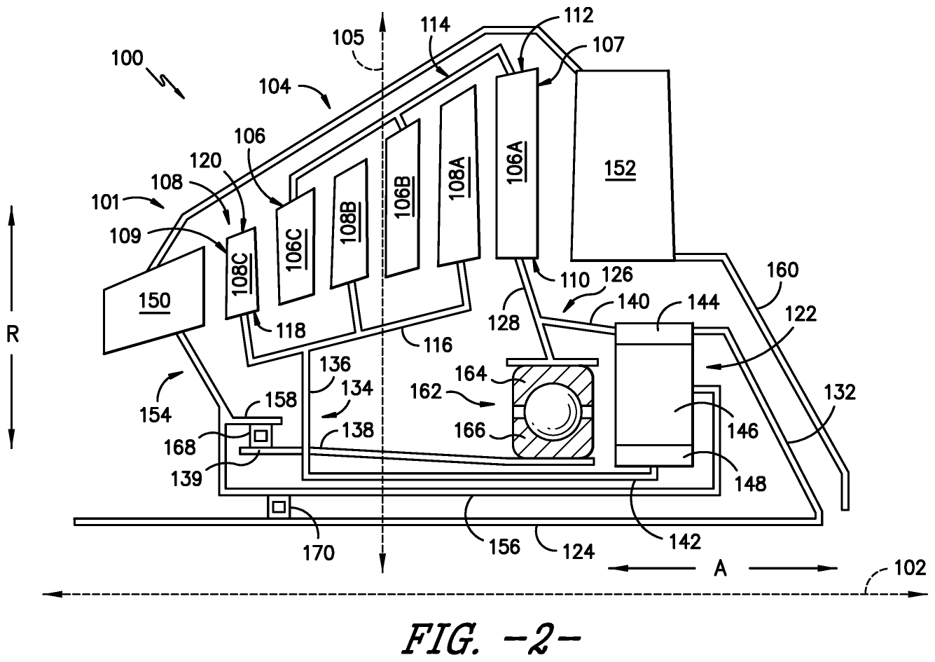

Referring now to FIG. 2, a schematic, side, cross-sectional view is provided of a turbine section 100 of a turbomachine in accordance with an exemplary embodiment of the present disclosure. The exemplary turbine section 100 depicted in FIG. 2 may be incorporated into, e.g., the exemplary turbofan engine 10 described above with reference to FIG. 1. However, in other exemplary embodiments, the turbine section 100 may be integrated into any other suitable machine utilizing a turbine.

Accordingly, it will be appreciated that the turbomachine generally defines a radial direction R, an axial direction A, and a longitudinal centerline 102. Further, the turbine section 100 includes a turbine 104, with the turbine 104 of the turbine section 100 being rotatable about the axial direction A (i.e., includes one or more components rotatable about the axial direction A). For example, in certain embodiments, the turbine 104 may be a low pressure turbine (such as the exemplary low pressure turbine 30 of FIG. 1), or alternatively may be any other turbine (such as a high pressure turbine, an intermediate turbine, a dual use turbine functioning as part of a high pressure turbine and/or a low pressure turbine, etc.).

Moreover, for the exemplary depicted embodiment, the turbine 104 includes a plurality of turbine rotor blades spaced along the axial direction A. More specifically, for the exemplary illustrated embodiment, the turbine 104 includes a first plurality of turbine rotor blades 106 and a second plurality of turbine rotor blades 108. As will be discussed in greater detail below, the first plurality of turbine rotor blades 106 and second plurality of turbine rotor blades 108 are alternatingly spaced along the axial direction A. Further, each turbine rotor blade 106, 108 defines an airfoil, such as including a pressure side, a suction side, a leading edge, and a trailing edge, to extract energy from combustion gases to induce rotation of a respective rotor assembly. It will be appreciated that where the turbine 104 corresponds to the LP turbine 30 of FIG. 1, the first plurality of turbine rotor blades 106 correspond to the first plurality of turbine rotor blades 72 and the second plurality of turbine rotor blades 108 correspond to the second plurality of turbine rotor blades 74.

Referring first to the first plurality of turbine rotor blades 106, each of the first plurality of turbine rotor blades 106 extends generally along the radial direction R between a radially inner end 110 and a radially outer end 112. Additionally, the first plurality of turbine rotor blades 106 includes a first turbine rotor blade 106A, a second turbine rotor blade 106B, and a third turbine rotor blade 106C, each spaced apart from one another generally along the axial direction A. At least two of the first plurality of turbine rotor blades 106 are spaced from one another along the axial direction A and coupled to one another at the respective radially outer ends 112. For instance, for the depicted embodiment, each of the first turbine rotor blade 106A, the second turbine rotor blade 106B, and the third turbine rotor blade 106C are coupled to one another through their respective radially outer ends 112. More specifically, each of the first turbine rotor blade 106A, the second turbine rotor blade 106B, and the third turbine rotor blade 106C of the first plurality of turbine rotor blades 106 are coupled at their respective radially outer ends 112 through an outer rotating drum 114.

Further, the second plurality of turbine rotor blades 108 each also extend generally along the radial direction R between a radially inner end 118 and a radially outer end 120. Additionally, for the illustrated embodiment, the second plurality of turbine rotor blades 108 includes a first turbine rotor blade 108A, a second turbine rotor blade 108B, and a third turbine rotor blade 108C, each spaced apart from another generally along the axial direction A. For the depicted embodiment, at least two of the second plurality of turbine rotor blades 108 are spaced from one another along the axial direction A and coupled to one another at the respective radially inner ends 118. For instance, as shown in the exemplary embodiment of FIG. 2, each of the first turbine rotor blade 108A, the second turbine rotor blade 108B, and the third turbine rotor blade 108C of the second plurality of turbine rotor blades 108 are coupled to one another through their respective radially inner ends 118. More specifically, each of the first turbine rotor blade 108A, the second turbine rotor blade 108B, and the third turbine rotor blade 108C of the second plurality of turbine rotor blades 108 are coupled at their respective radially inner ends 118 through an inner rotating drum 116.

It should be appreciated, however, that in other exemplary embodiments, the first plurality of turbine rotor blades 106 and/or the second plurality of turbine rotor blades 108 may be coupled together in any other suitable manner, and that as used herein, “coupled at the radially inner ends” and “coupled at the radially outer ends” refers generally to any direct or indirect coupling means or mechanism to connect the components. For example, in certain exemplary embodiments, the second plurality of turbine rotor blades 108 may include multiple stages of rotors (not shown) spaced along the axial direction A, with the first turbine rotor blade 108A, the second turbine rotor blade 108B, and the third turbine rotor blade 108C coupled to the respective stages of rotors at the respectively radially inner ends 118 through, e.g. dovetail base portions. The respective stages of rotors may, in turn, be coupled together to therefore couple the second plurality of turbine rotor blades at their respective radially inner ends 118. As another example, in other exemplary embodiments, the first plurality of turbine rotor blades 106 may be coupled to a plurality of disks that are connected to one another to thereby retain the first plurality of turbine rotor blades 106 in the turbine 104. Thus, in addition to or as an alternative to outer rotating drum 114 and/or inner rotating drum 116, other mechanisms for retaining the first plurality of turbine rotor blades 106 and/or the second plurality of turbine rotor blades 108 may be used.

Referring still to the depicted embodiment in FIG. 2, as stated, all the first plurality of turbine rotor blades 106 and the second plurality of turbine rotor blades 108 are alternatingly spaced along the axial direction A. As used herein, the term “alternatingly spaced along the axial direction A” refers to the second plurality of turbine rotor blades 108 including at least one turbine rotor blade 108 positioned along the axial direction A between two axially spaced turbine rotor blades of the first plurality of turbine rotor blades 106. For example, for the illustrated embodiment, alternatingly spaced along the axial direction A refers to the second plurality of turbine rotor blades 108 including at least one turbine rotor blade positioned between the first and second turbine rotor blades 106A, 106B of the first plurality of turbine rotor blades 106 along the axial direction A, or between the second and third turbine rotor blades 106B, 106C of the first plurality of turbine rotor blades 106 along the axial direction A. More specifically, for the depicted embodiment, the first turbine rotor blade 106A of the first plurality of turbine rotor blades 106 is positioned aft of the first turbine rotor blade 108A of the second plurality of turbine rotor blades 108; the second turbine rotor blade 106B of the first plurality of turbine rotor blades 106 is positioned between the first and second turbine rotor blades 108A, 108B of the second plurality of turbine rotor blades 108; and the third turbine rotor blade 106C of the first plurality of turbine rotor blades 106 is positioned between the second and third turbine rotor blades 108B, 108C of the second plurality of turbine rotor blades 108.

Notably, however, in other exemplary embodiments, the first plurality of turbine rotor blades 106 may have any other suitable configuration and/or the second plurality of turbine rotor blades 108 may have any other suitable configuration. For instance, it will be appreciated that for the embodiments described herein, the first turbine rotor blade 106A, second turbine rotor blade 106B, and third turbine rotor blade 106C of the first plurality of turbine rotor blades 106 generally represent a first stage of turbine rotor blades, a second stage of turbine rotor blades, and a third stage of turbine rotor blades, respectively. It will similarly be appreciated that the first turbine rotor blade 108A, second turbine rotor blade 108B, and third turbine rotor blade 108C of the second plurality of turbine rotor blades 108 each also generally represent a first stage of turbine rotor blades, a second stage of turbine rotor blades, and a third stage of turbine rotor blades, respectively. In other exemplary embodiments, the first plurality of turbine rotor blades 106 and/or the second plurality of turbine rotor blades 108 may include any other suitable number of stages of turbine rotor blades, such as two stages, four stages, etc., and in certain exemplary embodiments, the turbine 104 may additionally include one or more stages of stator vanes.

Referring still to FIG. 2, for the depicted embodiment, the turbomachine further includes a gearbox 122 and a spool 124, with the first plurality of turbine rotor blades 106 and the second plurality of turbine rotor blades 108 rotatable with one another through the gearbox 122. The spool 124 connects the turbine 104 with one or more components outside the turbine section 100. For example, in at least certain exemplary embodiments, the spool 124 may be configured as, e.g., the exemplary low pressure spool 36 described above with reference to FIG. 1 and the gearbox 122 may be configured as the power gearbox 46 shown in FIG. 1. In such exemplary embodiments, the turbine 104 may be configured as the low pressure turbine 30, and the spool 124 is the low speed, low pressure spool 36 drivingly connected to the low pressure compressor 22 of a compressor section disposed forward of the turbine section 30. It should be appreciated, however, that in other exemplary embodiments, the spool 124 may be any other spool (e.g., a high pressure spool, an intermediate spool, etc.), and, further, that the gearbox 122 may be any other suitable speed change device. For example, in other exemplary embodiments, the gearbox 122 may instead be a hydraulic torque converter, an electric machine, a transmission, etc.

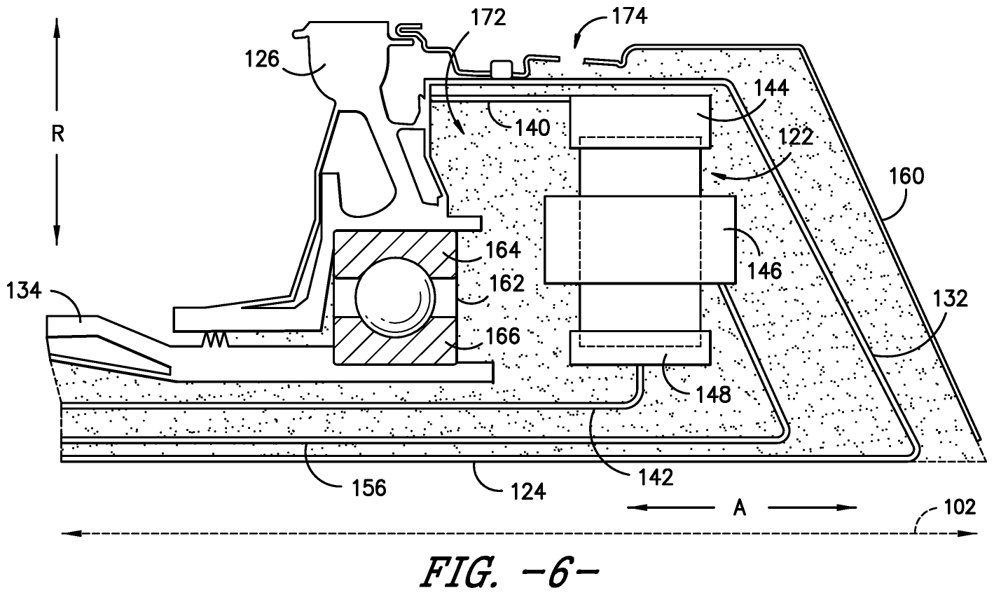

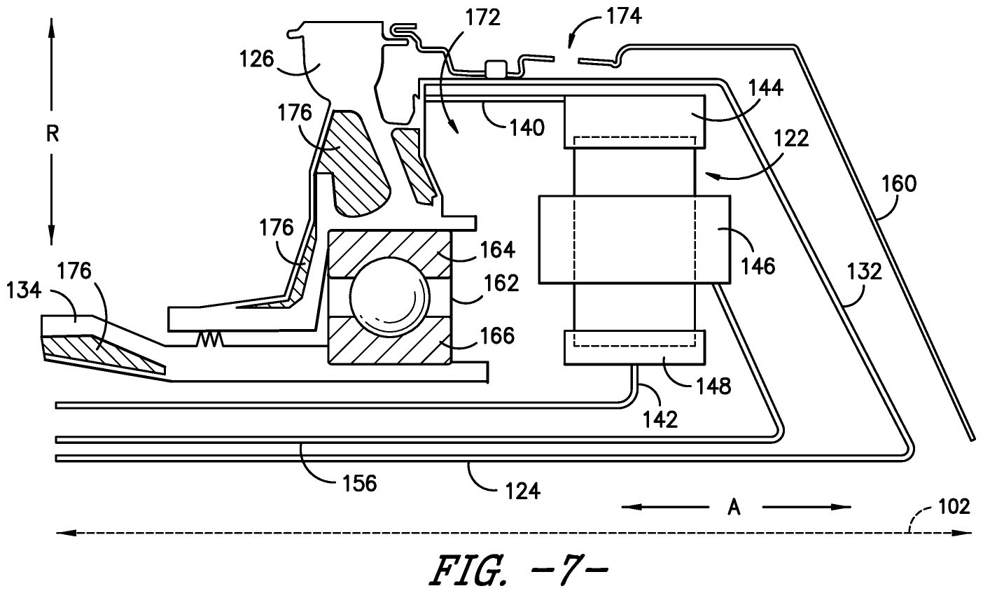

Further, the turbine section 100 includes a first support member assembly 126 having a first support member 128, and a second support member assembly 134 having a second support member 136. At least one turbine rotor blade of the first plurality of turbine rotor blades 106 is attached to the first support member assembly 126, and at least one turbine rotor blade of the second plurality of turbine rotor blades 108 is attached to the second support member assembly 134. For example, as shown in FIG. 2, the first support member 128 couples the radially inner end 110 of the first turbine rotor blade 106A of the first plurality of turbine rotor blades 106, and thereby couples the first plurality of turbine rotor blades 106, to a first rotational support 162. A first connection 140, which extends from the first support member 128, couples the first plurality of turbine rotor blades 106 to the gearbox 122, and an aft arm 132 couples the first plurality of turbine rotor blades 106 to the spool 124 through the gearbox 122. More particularly, the first support member assembly 126 is connected to the spool 124 through the gearbox 122 such that the gearbox 122 is positioned between the first rotational support 162 and the spool 124. However, in some embodiments, e.g., as illustrated in FIGS. 6 and 7, the first plurality of turbine rotor blades 106 may be coupled to the spool 124 via the aft arm 132 without passing through the gearbox 122. That is, in some embodiments, the first plurality of turbine rotor blades 106 may be connected to the aft arm 132, e.g., via a flange or the like, while bypassing the gearbox 122 such that the gearbox 122 is not involved with the torque transferred from the first plurality of turbine rotor blades 106 to the spool 124. In such embodiments, as depicted in FIGS. 6 and 7, the first connection 140 may still extend from the first support member assembly 126 to the gearbox 122, but the torque path bypasses the gearbox 122, passing along the connection between, e.g., the first support member 128 and the aft arm 132.

Additionally, the second support member 136 similarly couples the second plurality of turbine rotor blades 108 to the gearbox 122. An arm 138 extending from the second support member 136 couples the second plurality of turbine rotor blades 108 to the first rotational support 162. As such, both the first support member assembly 126 and the second support member assembly 134 are attached to both the first rotational support 162 and the gearbox 122. Notably, in other exemplary embodiments, the first support member 128 may couple to any of the turbine rotor blades within the first plurality of turbine rotor blades 106 at a radially inner end 110 (either directly or through, e.g., a rotor—not shown), and similarly, the second support member 136 may couple to any of the turbine rotor blades of the second plurality of turbine rotor blades 108 at a radially inner end 118 (either directly or through, e.g., a rotor—not shown).

Moreover, in the depicted embodiment, the first support member assembly 126 includes a first connection 140 attached to the first support member 128 (although, in other embodiments, the first connection 140 may be formed integrally with the first support member 128). Similarly, the second support member assembly includes a second connection 142 attached to, or formed integrally with, the second support member 136. The first connection 140 and the second connection 142 allow the first support member 128 and the second support member 136, respectively, to connect to the gearbox 122. In some embodiments, the first connection 140 and the second connection 142 may be rigid connections, but in other embodiments, either or both of the first connection 140 and the second connection 142 may be flexible connections. For instance, a flexible first connection 140 and flexible second connection 142 may allow for a less rigid connection between the gearbox 122 and the first support member 128 and second support member 136, respectively. More particularly, the flexible first connection 140 and the flexible second connection 142 may allow for a less rigid connection between the gearbox 122 and the first plurality of turbine rotor blades 106 and the second plurality of turbine rotor blades 108, respectively. In certain embodiments, the flexible first connection 140, the flexible second connection 142, or both may be configured as members having billows, splined connections with resilient material, etc. Further, as previously stated, whether the first and second connections 140, 142 are rigid or flexible, each of the first connection 140 and the second connection 142 may be separately or integrally formed with the respective support member 128, 134.

Keeping with FIG. 2, the exemplary turbine section 100 further includes a turbine center frame 150 and a turbine rear frame 152. A center frame support assembly 154 may be coupled to the turbine center frame 150. The center frame support assembly 154, for the depicted embodiment, includes a radially inner center frame support member 156 and a radially outer center frame support member 158. As further illustrated in FIG. 2, a rear frame support member 160 may be coupled to the turbine rear frame 152.

The exemplary gearbox 122 depicted in FIG. 2 generally includes a first gear coupled to the first plurality of turbine rotor blades 106, a second gear coupled to the second plurality of turbine rotor blades 108, and a third gear coupled to the turbine center frame 150. More specifically, for the illustrated embodiment, the gearbox 122 is configured as a planetary gear box. Accordingly, the first gear is a ring gear 144, the second gear is a sun gear 148, and the third gear is a planet gear 146. As such, in the exemplary embodiment illustrated in FIG. 2, the first plurality of turbine rotor blades 106 is coupled to the first gear, i.e., the ring gear 144, of the gearbox 122 through the first support member 128, and the second plurality of turbine rotor blades 108 is coupled to the second gear, i.e., the sun gear 148, of the gearbox 122 through the second support member 136. As further shown in the exemplary embodiment of FIG. 2, the plurality of planet gears 146 may be fixedly coupled (i.e., fixed along a circumferential direction) to the turbine center frame 150 through the center frame support assembly 154 and, more particularly, through the radially inner center frame support member 156 of the center frame support assembly 154. As illustrated, the inner center frame support member 156 may extend axially aft from a forward end 101 of the turbine section 100 to the gearbox 122, where the inner center frame support member 156 is coupled to the plurality of planet gears 146.

In such a manner, it will be appreciated that for the depicted embodiment, the first plurality of turbine rotor blades 106 are configured to rotate in an opposite direction than the second plurality of turbine rotor blades 108. For example, the first plurality of turbine rotor blades 106 may be configured to rotate in a first circumferential direction, while the second plurality of turbine rotor blades 108 may be configured to rotate in a second circumferential direction, opposite the first circumferential direction. It should be understood, however, that although the structures provided herein therefore enable the turbine 104 to “counter-rotate,” in other embodiments, the turbine 104 may instead be configured to “co-rotate,” wherein the first plurality of turbine rotor blades 106 and the second plurality of turbine rotor blades 108 each rotate the same circumferential direction.

It should further be understood that the first circumferential direction and the second circumferential direction as used and described herein are intended to denote directions relative to one another. Therefore, the first circumferential direction may refer to a clockwise rotation (viewed from downstream looking upstream) and the second circumferential direction may refer to a counter-clockwise rotation (viewed from downstream looking upstream). Alternatively, the first circumferential direction may refer to a counter-clockwise rotation (viewed from downstream looking upstream) and the second circumferential direction may refer to a clockwise rotation (viewed from downstream looking upstream).

It will further be appreciated that for the illustrated exemplary embodiment, the first plurality of turbine rotor blades 106 is configured as a plurality of low-speed turbine rotor blades, while the second plurality of turbine rotor blades 108 is configured as a plurality of high-speed turbine rotor blades. Such may be due to the gearing of the gearbox 122, as well as a positioning of the third turbine rotor blade 108C of the second plurality of turbine rotor blades 108 forward of the third turbine rotor blade 106C of the first plurality of turbine rotor blades 106. Regardless, it will be appreciated that in such an exemplary embodiment, the first support member 128 of the first support member assembly 126 is a low-speed support member (e.g., a low-speed rotor), and further, the second support member 136 of the second support member assembly 134 is configured as a high-speed support member (e.g., a high-speed rotor).

Referring still to the embodiment of FIG. 2, the turbine 104 further defines a midpoint 105 along the axial direction A. As used herein, the term “midpoint” refers generally to an axial location halfway between a forward-most forward edge of a forward-most turbine rotor blade of the turbine 104 and an aft-most aft edge of an aft-most turbine rotor blade of the turbine 104. Accordingly, for the depicted embodiment, the midpoint 105 of the turbine 104 is an axial location halfway between a forward-most forward edge 109 of the third turbine rotor blade 108C of the second plurality of turbine rotor blades 108 and an aft-most aft edge 107 of the first turbine rotor blade 106A of the first plurality of turbine rotor blades 106.

Moreover, the turbomachine includes a first rotational support 162 to support the various rotating components of the turbine 104 described herein. More specifically, for the depicted embodiment, the first support member assembly 126 and the second support member assembly 134 are supported within the turbine section 100 substantially completely through the first rotational support 162, such that the first rotational support 162 is an intershaft support, e.g., an intershaft bearing. For example, in the embodiment illustrated in FIG. 2, the first support member assembly 126 and the second support member assembly 134 are supported aft of the midpoint 105 of the turbine 104 substantially completely through the first rotational support 162. Further, the first rotational support 162 may be disposed at a location aft of the midpoint 105 of the turbine 104 but axially forward of the gearbox 122. Additionally or alternatively, the inner center frame support member 156 may be disposed between the first rotational support 162 and the spool 124. Thus, the first rotational support 162 may be an intershaft rotational support positioned between the first support member assembly 126 and the second support member assembly 134 but not directly on the main spool 124 (i.e., the rotor connecting the turbine section 100 to another portion of the turbomachine) because of the static structure (i.e., the turbine center frame 150) disposed between the intershaft rotational support 162 and the spool 124.

In some embodiments, at least one turbine rotor blade of the first or second pluralities of turbine rotor blades 106, 108 may be axially aligned with a portion of the first rotational support 162. For instance, as illustrated in FIG. 2, a majority of the first turbine rotor blade 106A of the first plurality of turbine rotor blades 106 is disposed radially outward from the first rotational support 162. As such, for the depicted embodiment, the first turbine rotor blade 106A is axially aligned from a portion of the first rotational support 162. Notably, as used herein, the term “aligned with” with reference to the axial direction A refers to the two components and/or positions having at least a portion of the same axial position.

Further, the axial gaps between the first plurality of turbine rotor blades 106 and the second plurality of turbine rotor blades 108 may be reduced compared to the axial gaps between the turbine rotor blades and turbine stator vanes of a typical turbine architecture. For instance, in a standard turbine architecture, the rotor to which the turbine rotor blades are attached may be coupled to a rotational support disposed forward of the turbine center frame. As a result, the turbine rotor blades and stator vanes typically experience a high degree of relative axial movement between rotor blades and stator vanes because of the relatively long distance or separation between the rotational support and the airfoils. In contrast, for the depicted exemplary embodiment of FIG. 2, the first rotational support 162 is disposed relatively close to the airfoils, i.e., the first and second pluralities of turbine rotor blades 106, 108. For example, rather than being disposed axially forward of the turbine center frame 150, the first rotational support 162 is disposed axially aft of the turbine midpoint 105 and is at least partially axially aligned with the first turbine rotor blade 106A of the first plurality of turbine rotor blades 106. Accordingly, relative axial movement between the first plurality of turbine rotor blades 106 and the second plurality of turbine rotor blades 108 may be reduced, and the axial gaps between the first plurality of turbine rotor blades 106 and the second plurality of turbine rotor blades 108 may be reduced. In exemplary embodiments, a reduction of approximately 50% or more in the axial gaps between adjacent blades 106, 108 may be achieved, compared to the axial gaps between standard or traditional turbine architecture. Reducing the axial gaps between the airfoils may result in an increase in efficiency of the turbomachine.

In exemplary embodiments, the first rotational support 162 is a ball bearing, with the first support member assembly 126 coupled to an outer race 164 of the first rotational support 162 and the second support member assembly 134 coupled to an inner race 166 of the first rotational support 162 as shown in FIG. 2. More particularly, for the illustrated embodiment, the first support member 128 is coupled to the outer race 164 and the arm 138 is coupled to the inner race 166. In other embodiments, however, the first rotational support 162 may be a rotational support other than a ball bearing, such as, e.g., a journal bearing, a thrust bearing, a roller bearing, etc. Moreover, the first support member assembly 126 may be coupled to the inner race 166 and the second support member assembly 134 may be coupled to the outer race 164.

In embodiments in which the first support member assembly 126 is a low-speed rotor and the second support member assembly 134 is a high-speed rotor of a counter-rotating turbine, such as a counter-rotating low pressure turbine 30, the first rotational support 162 is an intershaft support. More particularly, the first rotational support 162 may be an intershaft ball bearing between the high-speed rotor 134 and the low-speed rotor 126. In such embodiments, the intershaft ball bearing 162 supports the axial thrust and weight portion from the high-speed rotor 134. Further, as shown in FIG. 2, the inner center frame support member 156 may be disposed between the intershaft ball bearing 162 and the spool 124, which may be the low-speed, low pressure shaft or spool 36 of the gas turbine engine 10, such that the intershaft ball bearing 162 is not positioned directly on the spool 124. As such, the axial load may be transmitted to the spool 124 and may be supported by additional rotational supports as described in greater detail herein.

Further, for the exemplary depicted embodiment, the turbomachine further comprises a second rotational support 168 and a third rotational support 170. The second rotational support 168 is configured to further rotatably support the second support member assembly 134, and more specifically, is configured to support a forward segment 139 of the arm 138. The second rotational support 168, for the embodiment depicted in FIG. 2, is supported by the turbine center frame 150 through the radially outer center frame support member 158. That is, both the outer center frame support member 158 and the second support member assembly 134 are attached to the second rotational support 168, such that the second rotational support 168 provides support for the second support member assembly 134 and, in turn, is supported by the outer center frame support member 158. The third rotational support 170 is configured to rotatably support the spool 124, and in the exemplary embodiment of FIG. 2, is supported by the turbine center frame 150 through the radially inner center frame support member 156. That is, both the inner center frame support member 156 and the spool 124 are attached to the third rotational support 170, such that the third rotational support 170 provides support for the spool 124 and, in turn, is supported by the inner center frame support member 156. In the exemplary embodiment of FIG. 2, each of the second rotational support 168 and third rotational support 170 is disposed axially forward of the first rotational support 162, as well as axially forward of the turbine midpoint 105.

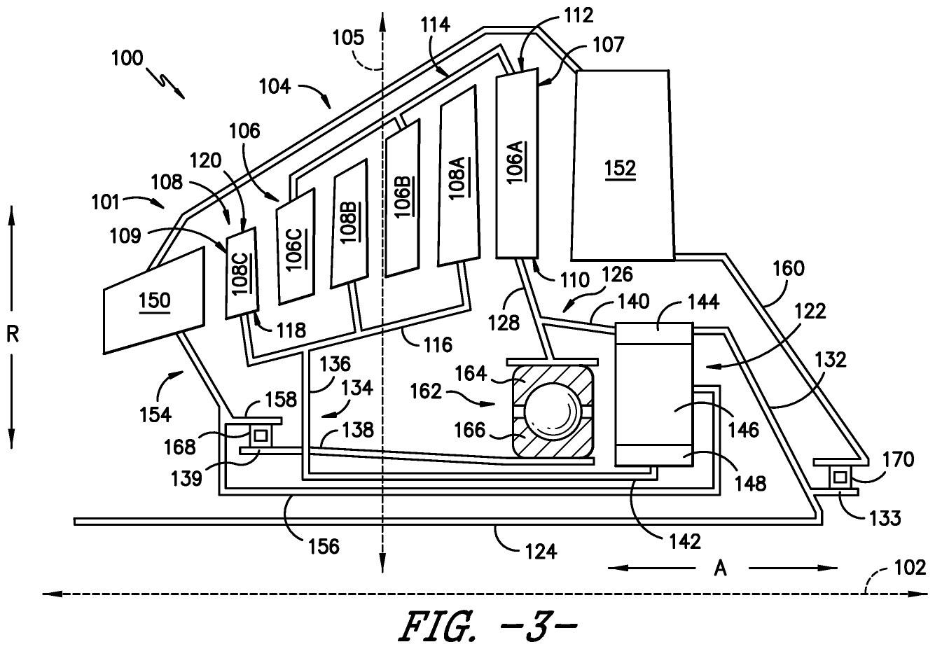

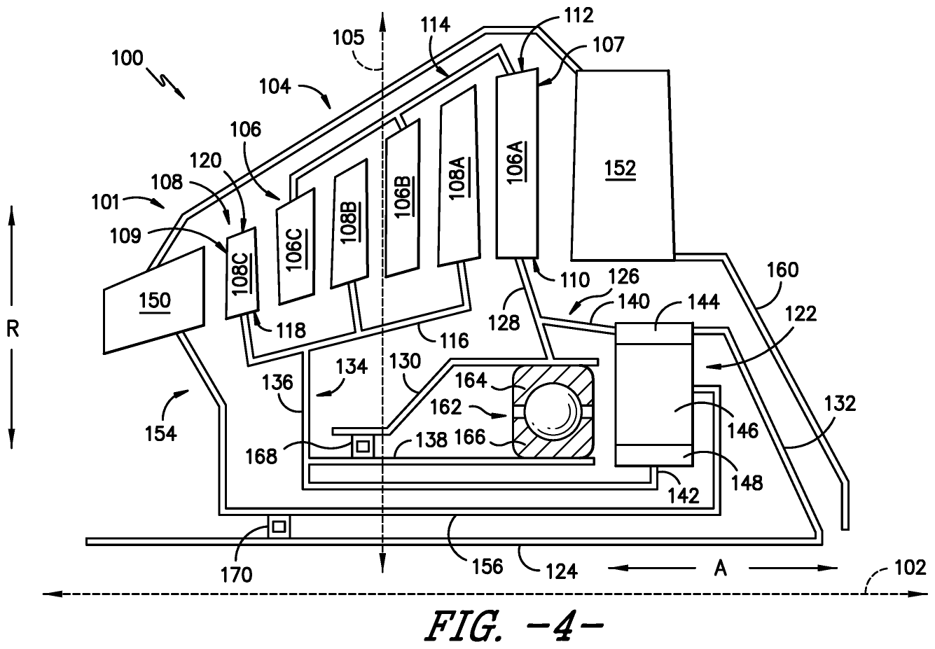

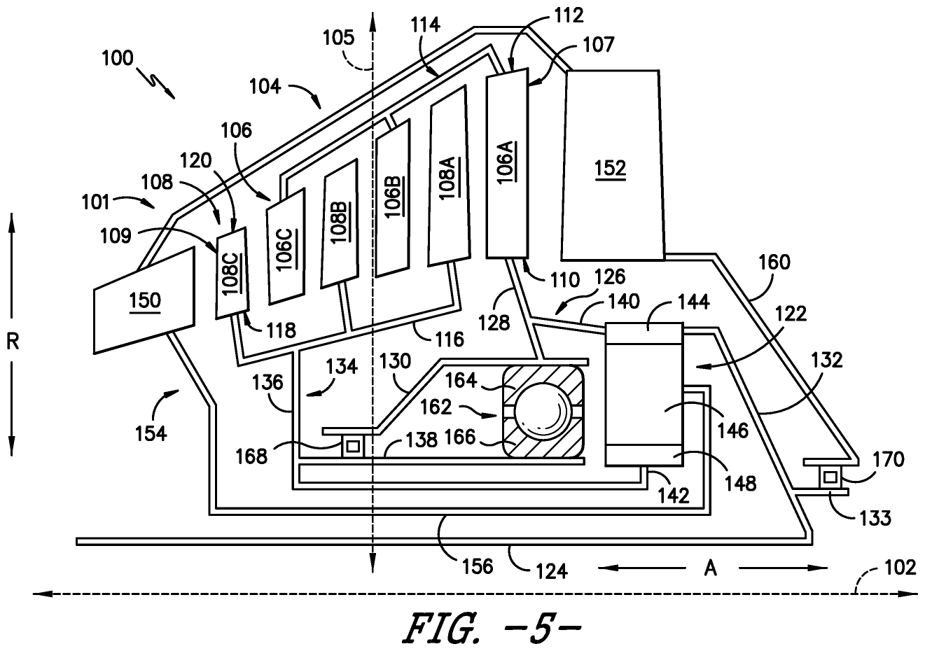

FIGS. 3, 4, and 5 illustrate alternate exemplary embodiments of the turbine section 100 in which the second rotational support 168 and/or the third rotational support 170 are disposed in different locations than as shown in the exemplary embodiment of FIG. 2. That is, either or both second rotational support 168 and the third rotational support 170 may be disposed in other locations within the turbine section 100 and still provide support to the first support member assembly 126 and the second support member assembly 134 (and, thereby, the first and second pluralities of turbine rotor blades 106, 108). It will be appreciated that the embodiments shown in FIGS. 3, 4, and 5 are otherwise substantially the same as the embodiment of FIG. 2, such that a recitation of the structure of the turbine section 100 need not be repeated for each of FIG. 3, FIG. 4, and FIG. 5.

Referring now to FIG. 3, in the depicted embodiment, the third rotational support 170 is disposed axially aft of the midpoint 105, as well as axially aft of the first rotational support 162 and the gearbox 122. As shown in the exemplary embodiment of FIG. 3, the third rotational support 170 is supported by the turbine rear frame 152 through the rear frame support member 160. More particularly, the third rotational support 170 is attached to both the rear frame support member 160 and an aft segment 133 of the aft arm 132 of the first support member assembly 126. In the embodiment of FIG. 3, the second rotational support 168 is configured similarly to the second rotational support 168 of the embodiment of FIG. 2.

In the exemplary embodiment of FIG. 4, the second rotational support 168 supports both the first support member assembly 126 and the second support member assembly 134. More particularly, both the first support member assembly 126 and the second support member assembly 134 are attached to the second rotational support 168. For example, as shown in FIG. 4, a forward arm 130 extending axially forward from the first support member 128 is attached to the second rotational support 168, and the arm 138 extending from the second support member 136 is attached to the second rotational support 168. Further, in the depicted embodiment, the second rotational support 168 is disposed axially forward of the first rotational support 162 and the gearbox 122. For instance, the second rotational support 168 is disposed forward of the midpoint 105 in the embodiment of FIG. 4, but in other embodiments, at least a portion of the second rotational support 168 may be disposed at or near the midpoint 105, or the second rotational support 168 may be disposed aft of the midpoint 105 but still forward of the first rotational support 162 and gearbox 122. It will be appreciated that, in exemplary embodiments such as shown in FIG. 4, the third rotational support 170 may be configured similarly to the third rotational support 170 of the embodiment of FIG. 2.

Turning to FIG. 5, the second rotational support 168 as shown in FIG. 4 and the third rotational support 170 as shown in FIG. 3 may be used in place of the second and third rotational supports 168, 170, respectively, of FIG. 2. For example, as depicted in FIG. 5, both the first support member assembly 126 and the second support member assembly 134 are attached to the second rotational support 168, which is disposed axially forward of the first rotational support 162 and the gearbox 122. More particularly, the second rotational support 168 in the embodiment of FIG. 5 is disposed forward of the midpoint 105, but as described with respect to FIG. 4, in other embodiments, at least a portion of the second rotational support 168 may be disposed at or near the midpoint 105, or the second rotational support 168 may be disposed aft of the midpoint 105 but still forward of the first rotational support 162 and gearbox 122. As further depicted in FIG. 5, the third rotational support 170 is disposed axially aft of the midpoint 105, as well as axially aft of the first rotational support 162 and the gearbox 122. More specifically, in the exemplary embodiment of FIG. 5, the third rotational support 170 is supported by the turbine rear frame 152 through the rear frame support member 160, and the third rotational support 170 is attached to both the rear frame support member 160 and an aft segment 133 of the aft arm 132 of the first support member assembly 126.

Other configurations of the second rotational support 168 and the third rotational support 170 with respect to the turbine section 100 may be used as well, and additional rotational supports also may be used. It will be appreciated that the first rotational support 162 supports the radial and axial load of the second plurality of turbine rotor blades 108, transmitted through the second support member assembly 134. The second rotational support 168, third rotational support 170, and any additional rotational supports provide additional support of the first support member assembly 126 and second support member assembly 134. For instance, in some embodiments, each of the second rotational support 168 and the third rotational support 170 may be a roller bearing providing additional support for the radial loads of the first and second support member assemblies 126, 134. Of course, the second, third, and any additional rotational supports may be any suitable rotational supports, such as ball bearings, journal bearings, thrust bearings, and the like.

Such configurations of the first rotational support 162, first and second support member assemblies 126, 134, and the gearbox 122, as well as second rotational support 168 and/or third rotational support 170 in embodiments including such additional rotational supports, may allow for the turbine 104 to be supported substantially completely through the turbine center frame 150. More particularly, the intershaft first rotational support 162 helps transfer the axial load of the second plurality of turbine rotor blades 108 to the static structure of the turbomachine. More particularly still, the intershaft rotational support 162 axially and radially connects the second support member assembly 134 of the second plurality of turbine rotor blades 108, which may be a high-speed rotor, to the first support member assembly 126 of the first plurality of turbine rotor blades 106, which may be a low-speed rotor. As such, the axial force generated in the second support member assembly 134, e.g., the high-speed rotor, may be transferred to the first support member assembly 126, e.g., a low-speed rotor. The axial load and at least a portion of the radial load from the second support member assembly 134 thereby may be transmitted directly to the spool 124, which is supported by other rotational supports. In embodiments of the turbomachine having a fan such as the fan 38, the entire axial thrust generated by the turbine 104 may be partially balanced by an axial force of the fan, and the resulting force (i.e., the portion not balanced by the fan's axial force) may be transferred to a forward or front static frame of the turbomachine, e.g., by means of a ball bearing positioned close to the fan, or axially forward of the turbine section 100. Thus, the intershaft rotational support 162 described herein may allow for a lighter turbine rear frame 152 and a more aerodynamic turbine rear frame 152. That is, a significant static structure may not be needed in the rear part of the turbomachine, i.e., near the turbine section 100, to support the axial load of the turbine 104.

Referring now to FIGS. 6 and 7, the arrangement of the first rotational support 162 and the gearbox 122 as described herein may provide other advantages as well. For example, referring to the exemplary embodiment of FIG. 6, the first rotational support 162 and the gearbox 122 may be disposed in a common sump 172. More particularly, the turbine section 100 may comprise a sump 172 as shown in FIG. 6, and both the first rotational support 162 and the gearbox 122 may be disposed in the sump 172 such that the sump 172 is common to both the first rotational support 162 and the gearbox 122. As such, the first rotational support 162 and the gearbox 122 may share a common air/oil chamber, i.e., the sump 172, which can reduce part count and complexity compared to other designs. Further, referring back to FIG. 4, in some embodiments the second rotational support 168 also may be disposed in the sump 172, further reducing the complexity of the turbine section 100 and the turbomachine.

What is more, as shown in FIG. 6, because the first rotational support 162 may be disposed in the same volume as the gearbox 122, e.g., in the same sump 172, a common scavenge line 174 may be adopted for both the first rotational support 162 and the gearbox 122. More specifically, the turbine section 100 may include a scavenge 174 for servicing both the first rotational support 162 and the gearbox 122. Accordingly, the scavenge 174 may be common to both the first rotational support 162 and the gearbox 122. Thus, as illustrated in the exemplary embodiment of FIG. 6, the first rotational support 162 and gearbox 122 may be positioned in the same sump 172 with a common scavenge 174.

Referring now to FIG. 7, the first rotational support 162 and the gearbox 122 may utilize the same thermal protection. More particularly, when the first rotational support 162 and the gearbox 122 are disposed in the same volume as depicted in FIG. 7, the same thermal protection may be adopted for the both the first rotational support 162 and the gearbox 122. As illustrated, the turbine section 100 may include a thermal barrier 176 for thermally shielding both the first rotational support 162 and the gearbox 122. As such, the thermal barrier 176 may be common to both the first rotational support 162 and the gearbox 122. The thermal barrier or shield 176 for the first rotational support 162 and the gearbox 122 may help avoid contact between high temperature components of the turbine section 100 and oil lubricating the first rotational support 162 and the gearbox 122 (e.g., oil contained in the common sump 172 that lubricates the first rotational support 162 and the gearbox 122 disposed in the sump 172). Further, using a single thermal barrier 176 for both the first rotational support 162 and the gearbox 122 allows a reduction of parts, e.g., only one barrier instead of two barriers may be used to protect both the first rotational support 162 and the gearbox 122. In exemplary embodiments, the thermal barrier 176 may be ambient air, but in other embodiments, the thermal barrier 176 may be formed from other insulating materials.

Accordingly, the present subject matter as described herein may improve traditional non-interdigitated turbine sections as well as existing interdigitated or counter-rotating turbine sections, e.g., by enabling improved fuel efficiency, operational efficiency, and/or power output while maintaining or reducing weight, part count, and/or packaging. As an example, the first rotational support described herein serves a double purpose, supporting axial thrust and supporting at least part of the weight of at least one support member assembly attached to the first rotational support. Further, the axial thrust that is not offset or balanced by an axial force of, e.g., a fan may be transferred to a static frame outside of the turbine section, thereby reducing the need for a static structure at or near the turbine section to support the axial load of the turbine rotors. As another example, as described herein, the axial gaps between airfoils may be reduced compared to existing turbine section designs, e.g., because the first rotational support may be disposed close to the airfoils, relative axial movement between the airfoils may be reduced, which can lead to an increase in efficiency of the turbomachine. Moreover, a reduction in parts and complexity of the turbomachine may be realized by positioning at least the first rotational support and the gearbox is the same volume, which, e.g., may allow a common sump, a common scavenge, and/or a common thermal barrier to be used for both the first rotational support and the gearbox.

Further, an interdigitated architecture provides certain advantages or benefits as well. For instance, the first plurality of turbine rotor blades interdigitated among the second plurality of turbine rotor blades may reduce packaging (e.g., longitudinal and/or radial dimensions) and reduce part count by removing stages of stationary airfoils between each rotating component. A reduction in part count may allow a reduction in cost of the turbomachine. Moreover, interdigitation as described herein may reduce a product of a flow area and the square of the rotational speed (the product herein referred to as “AN²”) of the turbomachine. For example, the turbomachine shown and described herein may generally reduce AN² relative to a conventional geared turbofan configuration. Generally, lowering the AN², such as by reducing the rotational speed and/or the flow area, increases the required average stage work factor (i.e., the average required loading on each stage of rotating airfoils). However, the systems described herein may lower the AN² while also lowering the average stage work factor and maintaining axial length of the turbine section (compared to engines of similar thrust output and packaging) by interdigitating turbine rotor blades of a low-speed rotor among the one or more stages of turbine rotor blades of a high-speed rotor. Therefore, the quantity of rotating stages of airfoils may increase while the average stage work factor, and therefore the AN², is reduced and increases in axial length to produce a similar AN² value are mitigated. Additionally or alternatively, the AN² may be reduced while also reducing the overall quantity of airfoils, rotating and stationary, in the turbine section relative to turbine sections of gas turbine engines of similar power output and/or packaging. Thus, embodiments of the present subject matter may limit radial and axial dimensions of a turbofan engine compared to a conventional turbofan engine. Further, the interdigitated architecture described herein may allow a reduction in engine weight compared to a conventional, non-interdigitated architecture. Moreover, the present subject matter encompasses counter-rotating turbine architectures, and a counter-rotating turbine may have increased efficiency compared to conventional turbofan architecture. Other advantages of the subject matter described herein also may be realized by those of ordinary skill in the art.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A turbomachine defining a radial direction and an axial direction, the turbomachine comprising:
a turbine section comprising a turbine, the turbine comprising a first plurality of turbine rotor blades and a second plurality of turbine rotor blades, the first plurality of turbine rotor blades and second plurality of turbine rotor blades alternatingly spaced along the axial direction, at least one turbine blade of the first plurality of turbine blades attached to a first support member assembly and at least one turbine blade of the second plurality of turbine blades attached to a second support member assembly;
a spool that connects the turbine with one or more components outside the turbine section;
a first rotational support, both the first support member assembly and the second support member assembly attached to the first rotational support; and
a gearbox, both the first support member assembly and the second support member assembly coupled to the gearbox such that the first plurality of turbine rotor blades and second plurality of turbine rotor blades are rotatable with one another through the gearbox.

2. The turbomachine of claim 1, further comprising:
a turbine center frame having an inner center frame support member and an outer center frame support member,
wherein the inner center frame support member is disposed between the first rotational support and the spool.

3. The turbomachine of claim 2, further comprising:
a second rotational support,
wherein both the outer center frame support member and the second support member assembly are attached to the second rotational support.

4. The turbomachine of claim 2, further comprising:
a third rotational support,
wherein both the inner center frame support member and the spool are attached to the third rotational support.

5. The turbomachine of claim 1, further comprising:
a second rotational support,
wherein both the first support member assembly and the second support member assembly are attached to the second rotational support.

6. The turbomachine of claim 1, further comprising:
a turbine rear frame having a rear frame support member; and
a third rotational support,
wherein both the rear frame support member and the first support member assembly are attached to the third rotational support.

7. The turbomachine of claim 1, wherein the first rotational support is a ball bearing.

8. The turbomachine of claim 1, wherein the first support member assembly is connected to the spool such that the gearbox is positioned between the first rotational support and the spool.

9. The turbomachine of claim 1, wherein the turbine is a low pressure turbine, and
wherein the spool is a low speed spool drivingly connected to a low pressure compressor of a compressor section disposed forward of the turbine section.

10. The turbomachine of claim 1, wherein the first rotational support is disposed forward of the gearbox.

11. The turbomachine of claim 1, wherein the first rotational support and the gearbox are disposed in a common sump.

12. The turbomachine of claim 1, further comprising:
a scavenge for servicing both the first rotational support and the gearbox such that the scavenge is common to both the first rotational support and the gearbox.

13. The turbomachine of claim 1, further comprising:
a thermal barrier for thermally shielding both the first rotational support and the gearbox such that the thermal barrier is common to both the first rotational support and the gearbox.

14. The turbomachine of claim 1, wherein at least one turbine rotor blade of the first or second pluralities of turbine rotor blades is axially aligned with a portion of the first rotational support.

15. The turbomachine of claim 1, wherein the first plurality of turbine rotor blades are configured to rotate in a first circumferential direction and the second plurality of turbine rotor blades are configured to rotate in a second circumferential direction, and
wherein the second circumferential direction is opposite the first circumferential direction.

16. A turbine section of a turbomachine, the turbine section comprising:
a turbine, the turbine comprising a first plurality of turbine rotor blades and a second plurality of turbine rotor blades, the first plurality of turbine rotor blades and second plurality of turbine rotor blades alternatingly spaced along the axial direction, at least one turbine blade of the first plurality of turbine blades attached to a first support member assembly and at least one turbine blade of the second plurality of turbine blades attached to a second support member assembly;
a first rotational support, both the first support member assembly and the second support member assembly attached to the first rotational support;
a gearbox, both the first support member assembly and the second support member assembly coupled to the gearbox such that the first plurality of turbine rotor blades and second plurality of turbine rotor blades are rotatable with one another through the gearbox; and
a turbine center frame having an inner center frame support member extending axially aft from a forward end of the turbine section to the gearbox,
wherein the first support member assembly is connected to a spool, and
wherein the inner center frame support member is disposed between the first rotational support and the spool.

17. The turbine section of claim 16, wherein the first support member assembly is connected to the spool such that the gearbox is positioned between the first rotational support and the spool.

18. The turbine section of claim 17, further comprising:
a second rotational support; and
a third rotational support,
wherein both an outer center frame support member of the turbine center frame and the second support member assembly are attached to the second rotational support, and
wherein both the inner center frame support member and the spool are attached to the third rotational support.

19. The turbine section of claim 16, further comprising:
a sump, both the first rotational support and the gearbox disposed in the sump such that the sump is common to both the first rotational support and the gearbox;
a scavenge for servicing both the first rotational support and the gearbox such that the scavenge is common to both the first rotational support and the gearbox; and
a thermal barrier for thermally shielding both the first rotational support and the gearbox such that the thermal barrier is common to both the first rotational support and the gearbox.

20. A turbine section of a turbomachine, the turbine section comprising:
a low pressure turbine, the low pressure turbine comprising a first plurality of turbine rotor blades and a second plurality of turbine rotor blades, the first plurality of turbine rotor blades and second plurality of turbine rotor blades alternatingly spaced along the axial direction, at least one turbine blade of the first plurality of turbine blades attached to a first support member assembly and at least one turbine blade of the second plurality of turbine blades attached to a second support member assembly;
a ball bearing, each of the first support member assembly and the second support member assembly attached to the ball bearing;
a gearbox, each of the first support member assembly and the second support member assembly coupled to the gearbox such that the first plurality of turbine rotor blades and second plurality of turbine rotor blades are rotatable with one another through the gearbox; and
a turbine center frame having an inner center frame support member extending axially from a forward end of the turbine section aft to the gearbox,
wherein the first plurality of turbine rotor blades are configured to rotate in a first circumferential direction and the second plurality of turbine rotor blades are configured to rotate in a second circumferential direction, the second circumferential direction opposite the first circumferential direction,
wherein the first support member assembly is connected to a low speed spool, the low speed spool drivingly connected to a low pressure compressor disposed forward of the turbine section, and
wherein the inner center frame support member is disposed between the ball bearing and the low speed spool.
